(19) United States
(12) Patent Application Publication
(10) Pub. No.: US 2016/0221190 A1
(43) Pub. Date: Aug. 4, 2016

(54) LEARNING MANIPULATION ACTIONS FROM UNCONSTRAINED VIDEOS

(71) Applicants: Yiannis ALOIMONOS, College Park, MD (US); Cornelia FERMULLER, College Park, MD (US); Yezhou YANG, Hyattsville, MD (US); Yi LI, Canberra (AU); Katerina PASTRA, Athens (GR)

(72) Inventors: Yiannis ALOIMONOS, College Park, MD (US); Cornelia FERMULLER, College Park, MD (US); Yezhou YANG, Hyattsville, MD (US); Yi LI, Canberra (AU); Katerina PASTRA, Athens (GR)

(21) Appl. No.: 15/011,025

(22) Filed: Jan. 29, 2016

Related U.S. Application Data
(60) Provisional application No. 62/109,134, filed on Jan. 29, 2015.

(51) Int. Cl. B25J 9/16

(52) U.S. Cl. CPC B25J 9/1661; B25J 9/1697; B25J 9/1669

(57) ABSTRACT

Various systems may benefit from computer learning. For example, robotics systems may benefit from learning actions, such as manipulation actions, from unconstrained videos. A method can include processing a set of video images to obtain a collection of semantic entities. The method can also include processing the semantic entities to obtain at least one visual sentence from the set of video images. The method can further include deriving an action plan for a robot from the at least one visual sentence. The method can additionally include implementing the action plan by the robot. The processing the set of video images, the processing semantic entities, and the deriving the action plan can be computer implemented.

### CROSS-REFERENCE TO RELATED APPLICATION

This application is related to and claims the benefit and priority of U.S. Provisional Patent application No. 62/109,134, filed Jan. 29, 2015, the entirety of which is hereby incorporated herein by reference.

### GOVERNMENT LICENSE RIGHTS

This invention was made with government support under INSPIRE grant SMA1248056 awarded by NSF and under grant W911NF1410384 awarded by the US Army. The government has certain rights in the invention.

### BACKGROUND

1. Field

Various systems may benefit from computer learning. For example, robotics systems may benefit from learning actions, such as manipulation actions, from unconstrained videos.

2. Description of the Related Art

The ability to learn actions from human demonstrations is a challenge for the development of intelligent systems. Action generation and creation in robots has not conventionally evolved beyond learning simple schemas. In other words, existing approaches copy exact movement, as shown by demonstration on the robot.

Most work on learning from demonstrations in robotics has been conducted in fully controlled lab environments. Many of the approaches rely on RGBD sensors, motion sensors, or specific color markers, as opposed to unconstrained video. The conventional systems resulting from such approaches are fragile in real world situations. Conventional systems applied to unconstrained videos do not allow traditional feature extraction and learning mechanisms to work robustly.

### SUMMARY

According to certain embodiments, a method can include processing a set of video images to obtain a collection of semantic entities. The method can also include processing the semantic entities to obtain a description of the ongoing action, called visual sentence. The method can further include deriving an action plan for a robot from the at least one visual sentence. The method can additionally include implementing the action plan by the robot. The processing of the set of video images, the processing of semantic entities, and the deriving of the action plan are computer implemented.

An apparatus, in certain embodiments, may include at least one processor and at least one memory including computer program code. The at least one memory and the computer program code can be configured to, with the at least one processor, cause the apparatus at least to process a set of video images to obtain a collection of semantic entities. The at least one memory and the computer program code can also be configured to, with the at least one processor, cause the apparatus at least to process the semantic entities to obtain at least one visual sentence from the set of video images. The at least one memory and the computer program code can further be configured to, with the at least one processor, cause the apparatus at least to derive an action plan for a robot from the at least one visual sentence. The at least one memory and the computer program code can additionally be configured to, with the at least one processor, cause the apparatus at least to implement the action plan by the robot.

In certain embodiments, an apparatus can include means for processing a set of video images to obtain a collection of semantic entities. The apparatus can also include means for processing the semantic entities to obtain at least one visual sentence from the set of video images. The apparatus can further include means for deriving an action plan for a robot from the at least one visual sentence. The apparatus can additionally include means for implementing the action plan by the robot.

A non-transitory computer-readable medium, according to certain embodiments, can be encoded with instructions that, when executed in hardware, perform a process. The process can include processing a set of video images to obtain a collection of semantic entities. The process can also include processing the semantic entities to obtain at least one visual sentence from the set of video images. The process can further include deriving an action plan for a robot from the at least one visual sentence. The process can additionally include implementing the action plan by the robot.

### BRIEF DESCRIPTION OF THE DRAWINGS

For proper understanding of the invention, reference should be made to the accompanying drawings, wherein:

FIG. 1 illustrates a system according to certain embodiments.

FIG. 2 illustrates grasp categories as used in certain embodiments.

FIG. 3 lists object classes in certain embodiments.

FIG. 4 illustrates rules of a probabilistic grammar according to certain embodiments.

FIG. 5 illustrates sample output trees according to certain embodiments.

FIG. 6 illustrates final control commands generated by reverse parsing according to certain embodiments.

FIG. 7 illustrates a method according to certain embodiments.

FIG. 8 illustrates a system according to certain embodiments.

### DETAILED DESCRIPTION

Certain embodiments of the present invention relate to a computational method to create descriptions of human actions in video. An input to this method can be video. An output can be a description in the form of so-called predicates. These predicates can include a sequence of small atomic actions, which detail the grasp types of the left and right hand, the movements of the hands and arms, and the objects and tools involved. This action description may be sufficient to perform the same actions with robots. The method may allow a robot to learn how to perform actions from video demonstration. For example, certain embodiments of the method can be used to learn from a cooking show how to cook certain recipes. Alternatively, the method may be used to learn from an expert demonstrating the assembly of a piece of furniture, how to perform the assembly.

As will be discussed below, certain embodiments can provide a computerized system to automatically interpret and represent human actions in video. The system can represent an action as a sequence of atomic actions that make up the complete activity observed in the video. One benefit or advantage may be to acquire knowledge and training for robots, such as android robots. Indeed, the learned actions can subsequently be implemented by robots.

A system according to certain embodiments of the present invention can be structured with two levels. A lower level of the system can include image processing tools that obtain from video various semantic entities, such as the objects and tools seen, the human body parts, the hand grasp types, and the movements of the humans' body parts.

Among other approaches, the system can rely on convolutional neural network (CNN) based recognition modules for classifying the hand grasp type and for object recognition.

At a higher level, a probabilistic manipulation action grammar based parsing module can generate visual sentences for robot manipulation. This module can employ a minimalist action grammar, with a small set of rules. The symbols of the grammar can correspond to meaningful parts of the observed video. This way interpreting the action in a video can be analogous to understanding a sentence that we read or hear.

Parsing the video can include segmenting the video in time and extracting particular symbols involving objects, tools, and movement. Furthermore, language processing, using information from, for example, the Gigaword Corpus can be employed to help with the description of the actual action or verb.

Possible applications of certain embodiments of the present invention include the automatic interpretation of human actions from video, in order to enable robots to automatically learn how to perform actions. Certain embodiments can be adapted to specific respective domains of knowledge. Examples include learning to cook from cooking shows or learning assembly actions, such as assembling an article, for example furniture or a car.

Another application of certain embodiments may be for monitoring humans in the world in real-time. An example is a system monitoring humans in manufacturing to prevent or detect errors that possibly could occur.

In order to advance action generation and creation in robots beyond simple learned schemas, and for other reasons, certain embodiments provide computational tools that permit automatic interpretation and representation of human actions.

Certain embodiments of the present invention provide a system that learns manipulation action plans by processing unconstrained videos from the World Wide Web. The system may be able to robustly generate the sequence of atomic actions of seen longer actions in video in order to acquire knowledge for robots.

A lower level of the system can include two convolutional neural network (CNN) based recognition modules, one for classifying hand grasp type and the other for object recognition.

A higher level of the system can include a probabilistic manipulation action grammar based parsing module that aims at generating visual sentences for robot manipulation.

The system may be able to learn manipulation actions by “watching” unconstrained videos with high accuracy. These may be demo videos, such as videos taken from the world wide web (WWW).

Actions of manipulation can be represented at multiple levels of abstraction. At lower levels, the symbolic quantities can be grounded in perception, while at the higher levels a grammatical structure can represent symbolic information, such as objects, grasping types, and actions.

Certain embodiments of the present invention can employ deep neural network approaches, such as a convolution neural network (CNN) based object recognition module and a CNN based grasping type recognition module. The latter module can be configured to recognize a subject's grasping type directly from image patches.

The grasp type may be a component in the characterization of manipulation actions. From the viewpoint of processing videos, the grasp can contain information about the action itself, and it can be used for prediction or as a feature for recognition. The grasp can also contain information about the beginning and end of action segments. Thus, changes in grasp can be used to segment videos in time.

Knowledge about how to grasp a given object may be useful for a robot to arrange its effectors, for example to perform an equivalent to an observed human activity. For example, consider a humanoid robot with one parallel gripper and one vacuum gripper. When a power grasp is desired, the robot can select the vacuum gripper for a stable grasp, but when a precision grasp is desired, the parallel gripper may be a better choice. Thus, knowing the grasping type can provide information for the robot to plan the configuration of its effectors, or even the type of effector to use.

In order to perform a manipulation action, the robot can learn what tool to grasp and on what object to perform the action. While the tool is also an object, and while both the object and the tool can be identified using object recognition, in certain cases it can be useful to distinguish between the tool object and the worked-on object, which can be simply referred to as an object. The system, according to certain embodiments, can apply CNN based recognition modules to recognize the objects and tools in the video.

Given the beliefs of the tool and object from the output of the recognition modules, the system can predict the most likely action using language, by mining a large corpus using a technique similar to that described in Yang et al. “Corpus-guided sentence generation of natural images,” in Proceedings of the Conference on Empirical Methods in Natural Language Processing, 444-454 (2011).

Putting everything together, the output from the lower level visual perception system can be in the form of (LeftHand GraspType1 Object1 Action RightHand GraspType2 Object2). This septet of quantities is referred to as a visual sentence.

At the higher level of representation, the system can generate a symbolic command sequence. A context-free grammar and related operations can be used to parse manipulation actions. Moreover, manipulation actions can be modeled using a probabilistic variant of the content-free grammar and by explicitly modeling the grasping type.

Using as input the belief distributions from the CNN based visual perception system, a Viterbi probabilistic parser can be used to represent actions in form of a hierarchical and recursive tree structure. This structure can innately encode the order of atomic actions in a sequence, and can form the basic unit of a knowledge representation. By reverse parsing it, the system can generate a sequence of atomic commands in predicate form, such as Action(Subject, Patient) plus the temporal information necessary to guide the robot. This information can then be used to control robot effectors.

Certain embodiments of the present invention can provide at least two features. First, in certain embodiments a convolutional neural network based method can achieve state-of-the-art performance in grasping type classification and object recognition on unconstrained video data. Second, in certain embodiments a system can learn information about human manipulation action by linking lower level visual perception and higher level semantic structures through a probabilistic manipulation action grammar. For example, certain embodiments provide a detailed representation of manipulation actions, the grammar trees.

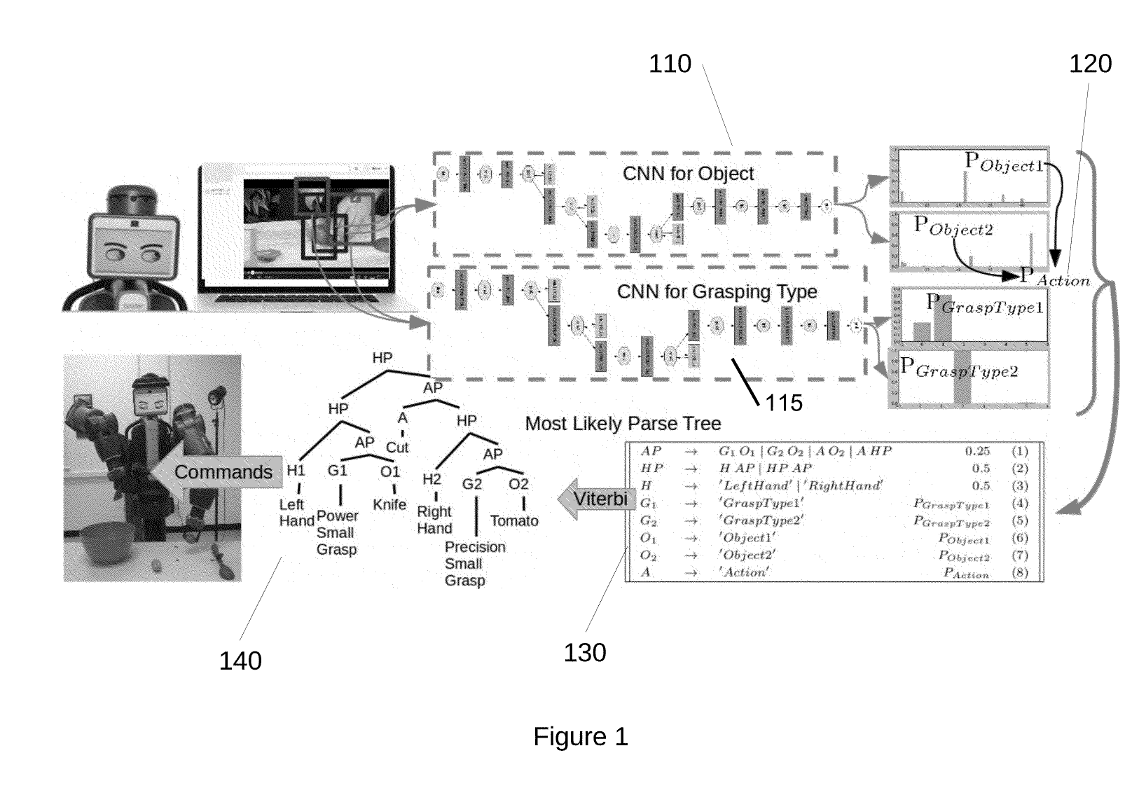

FIG. 1 illustrates a system according to certain embodiments. The system of FIG. 1 may learn manipulation actions from unconstrained videos. The system can combine the robustness of CNN based visual processing with the generality of an action grammar based parser. FIG. 1 shows an integrated approach that combines such features.

As shown in FIG. 1, the system can include CNN based visual recognition. The system can include at least two visual recognition modules, a module 115 for classification of grasping types and a module 110 for recognition of objects, broadly including both tools and worked-on objects. In both modules convolutional neural networks can be used as classifiers.

Convolutional Neural Network (CNN) is a multilayer learning framework, which may include an input layer, a few convolutional layers and an output layer. The goal of CNN can be to learn a hierarchy of feature representations.

Response maps in each layer can be convolved with a number of filters and further down-sampled by pooling operations. These pooling operations can aggregate values in a smaller region by downsampling functions including max, min, and average sampling. The learning in CNN can be based on Stochastic Gradient Descent (SGD), which can include two main operations: Forward and BackPropagation. More details on convolutional networks can be found in “The handbook of brain theory and neural networks,” chapter “Convolutional networks for images, speech, and time series,” pp. 255-258 (1998) of LeCun and Bengio.

Certain embodiments of the present invention can use, for example, a seven layer CNN, including the input layer and two perception layers for regression output. The first convolution layer can have 32 filters of size 5×5, the second convolution layer can have 32 filters of size 5×5, and the third convolution layer can have 64 filters of size 5×5, respectively. The first perception layer can have 64 regression outputs and the final perception layer can have 6 regression outputs.

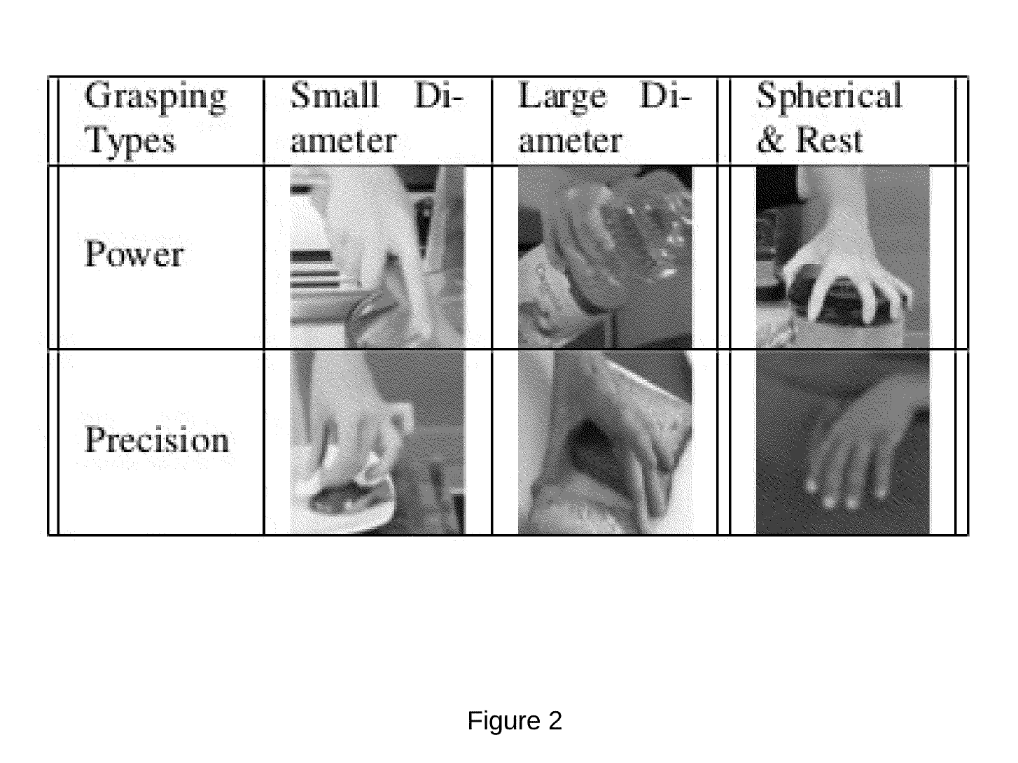

FIG. 2 illustrates grasp categories as used in certain embodiments. The system can consider 6 grasping type classes. First, the grasps can be distinguished into power and precision grasps. Power grasping can be used when the object needs to be held firmly in order to apply force, such as “gripping a knife to cut.” Precision grasping can be used in order to do fine grain actions that require accuracy, such as “pinching a needle.”

The power grasps can then be distinguished regarding whether they are spherical or otherwise, for example cylindrical. The latter category can be distinguished according to the grasping diameter, into large diameter and small diameter cylindrical grasps.

Similarly, the precision grasps can be distinguished into large and small diameter grasps. Additionally, a rest position can be considered, in which no grasping is performed. These six grasps, including the rest position, are denoted as G in the following discussion.

Referring again to FIG. 1, an input to the grasping type recognition module 114 can be a gray-scale image patch around a target hand performing the grasping. Each patch can be resized to 32×32 pixels, and subtract the global mean obtained from the training data.

For each testing video with M frames, the target hand patches (left hand and right hand, if present) can be passed frame by frame, yielding an output of size 6×M. The patches of a sequence of frames can be summed up and the output can be normalized. The classification for each of the hands can be used to obtain (GraspType1) for the left hand, and (GraspType2) for the right hand. For the video of M frames, the grasping type recognition system 115 can output two belief distributions of size 6×1: P_{GroupType1} and P_{GroupType2}.

An input to object recognition module 110 can be an RGB image patch around the target object. Each patch can be resized to 32×32×3 pixels, and a global mean obtained from the training data can be subtracted.

Similar to the processing in grasping type recognition module 115, the objection recognition module 110 can also use a seven layer CNN. The network structure can be the same as described above, except that the final perception layer can have 48 regression outputs. The system can consider 48 object classes. This candidate object list is referred to as O in the following discussion.

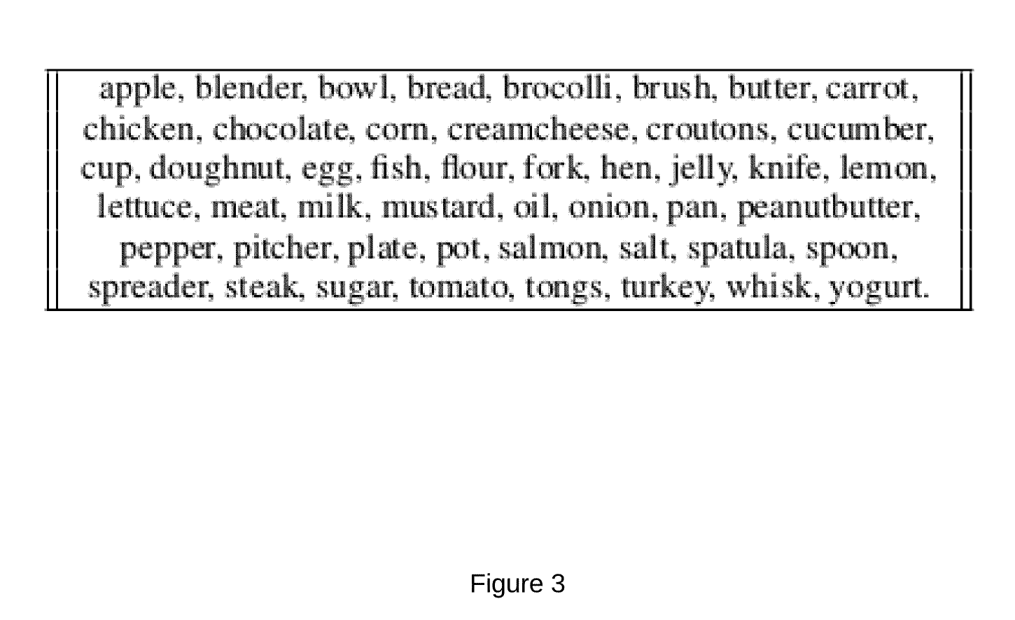

FIG. 3 lists object classes in certain embodiments. As shown in FIG. 3, the object classes can include a variety of ingredients or objects, such as apply, bread, and broccoli, as well as a variety of tools, such as blender, bowl, and brush.

For each testing video with M frames, the target object patches can be passed frame by frame, and an output can be obtained, having size 48×M. The output can be summed up in the temporal dimension and then normalized. Two objects can be classified in the image: (Object1) and (Object2). At the end of classification, the object recognition system 110 can output two belief distributions of size 48×1: P_{Object1} and P_{Object2}.

In view of the above, the system may still need to determine the “Action” that was performed. Due to the large variations in the video, the visual recognition of actions may be difficult. Certain embodiments of the present invention can bypass this issue by using a trained language model. The model can predict the most likely verb as the “Action” and can associate it with the objects (Object1, Object2).

In order to do prediction, a set of candidate actions V can be considered. Here, the top ten most common actions in cooking scenarios can be used in certain embodiments. These actions can be, for example, the following: Cut, Pour, Transfer, Spread, Grip, Stir, Sprinkle, Chop, Peel, and Mix.

An action prediction module 120 can compute the probability of a verb occurring, given the detected nouns, P(Action|Object1, Object2). This calculation may be based, for example, on the Gigaword corpus, see “English gigaword,” in Linguistic Data Consortium, by Graff (2003).

The probability of a verb occurring can be determined by computing the log-likelihood ratio of trigrams (Object1, Action, Object2), computed from the sentence in the English Gigaword corpus. This can be done by extracting only the words in the corpus that are defined in O and V, including their synonyms. This process of extraction can produce a reduced corpus sequence from which target trigrams can be obtained. The log-likelihood ratios computed for all possible trigrams can then be normalized to obtain P(Action|Object1, Object2). For each testing video, a belief distribution can be computed over the candidate action set V of size 10×1 as:

$${P}_{Action} = {\sum }_{Object 1 ∈ O}^{ } {\sum }_{Object 2 ∈ O}^{ } P ( \vert Action \vert Object 1 , Object 2 ) \times {P}_{Object 1} \times {P}_{Object 2}$$

The output of the visual system can be belief distributions of the object categories, grasping types, and actions. However, these distributions may not be sufficient for a robot to execute actions. A robot may also need to understand the hierarchical and recursive structure of the action.

Grammar trees, similar to those used in linguistics analysis, may be a good representation for capturing the structure of actions. Certain embodiments of the present invention integrate the visual system with a manipulation action grammar based parsing module.

When the output of the visual system is probabilistic, the grammar can be a probabilistic grammar. A Viterbi probabilistic parser 130 can be applied to select the parse tree with the highest likelihood among the possible candidates.

Because grasping is conceptually different from other actions, when the system employs a CNN based recognition module to extract the model grasping type, an additional nonterminal symbol G can be assigned to represent the grasp. To accommodate the probabilistic output from the processing of unconstrained videos, the manipulation action grammar can be a probabilistic one.

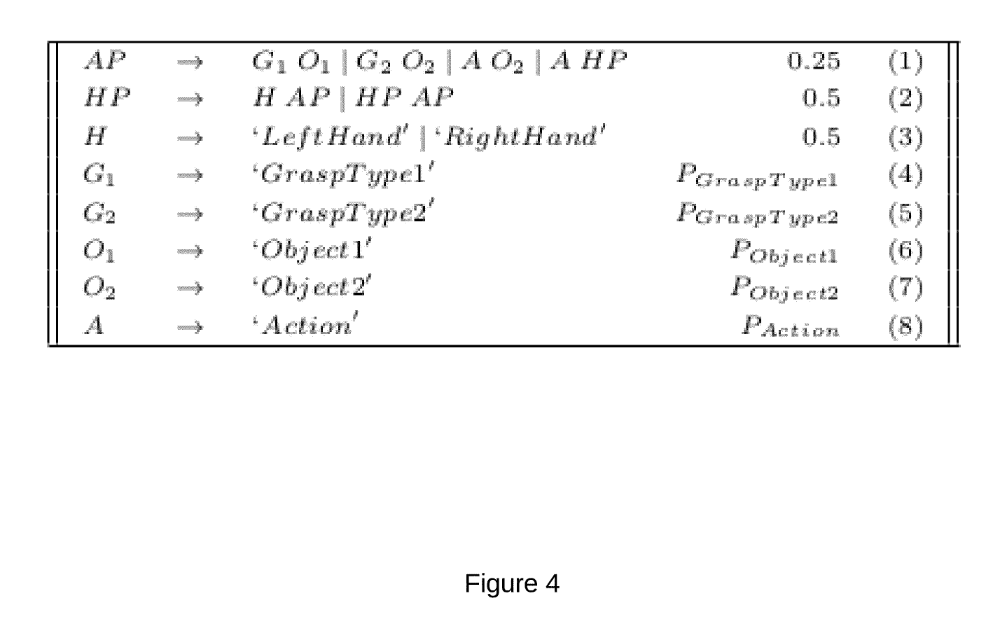

FIG. 4 illustrates rules of a probabilistic grammar according to certain embodiments. The design of this grammar can take into account a variety of characteristics. Hands are the main driving force in manipulation actions, so a specialized nonterminal symbol H can be used for their representation. An action (A) or a grasping (G) can be applied to an object (O) directly or to a hand phrase (HP), which in turn can contain an object (O), as encoded in Rule (1), which builds up an action phrase (AP). An action phrase (AP) can be combined either with the hand (H) or a hand phrase (HP), as encoded in Rule (2), which can recursively build up the hand phrase (HP).

The rules illustrated in FIG. 4 can form the syntactic rules of the grammar. To make the grammar probabilistic, each sub-rule in rules (1) and (2) can be treated equally, and equal probability can be assigned to each sub-rule. With regard to the hand H in rule (3), a robot with two effectors or arms can be considered, and an equal probability can be assigned to “LeftHand” and “RightHand.” For the terminal rules (4-8), assign the normalized belief distributions (P_{Object1}, P_{Object2}, P_{GraspType1}, P_{GraspType2}, P_{Action}) obtained from the visual processes can be assigned to each candidate object, grasping type and action.

A bottom-up variation of a probabilistic context-free grammar parser that uses dynamic programming, also known as a Viterbi parser 130, can be used to find the most likely parse for an input visual sentence. The Viterbi parser 130 can parse the visual sentence by filling in the most likely constituent table. Moreover, the parser 130 can use the grammar illustrated in FIG. 4.

For each testing video, the system can output the most likely parse tree of the specific manipulation action. By reversely parsing the tree structure, a robot can derive an action plan for execution.

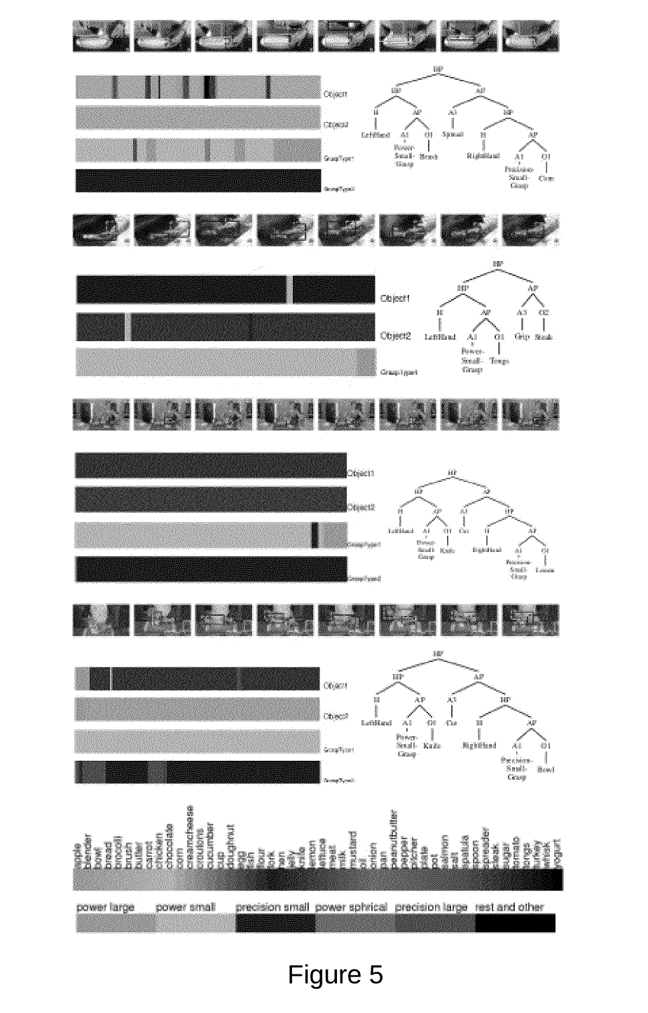

FIG. 5 illustrates sample output trees according to certain embodiments. These are simply four examples of possible output trees that may be the output of Viterbi parser 130. Each of the four examples includes a first row of input unconstrained video frames. Proceeding counter-clockwise, the next section of each example illustrates coded visual recognition output frame by frame along the timeline. A legend of the coding is at the bottom of the figure. Finally, the lower right of each example is a most likely parse tree generated for each clip.

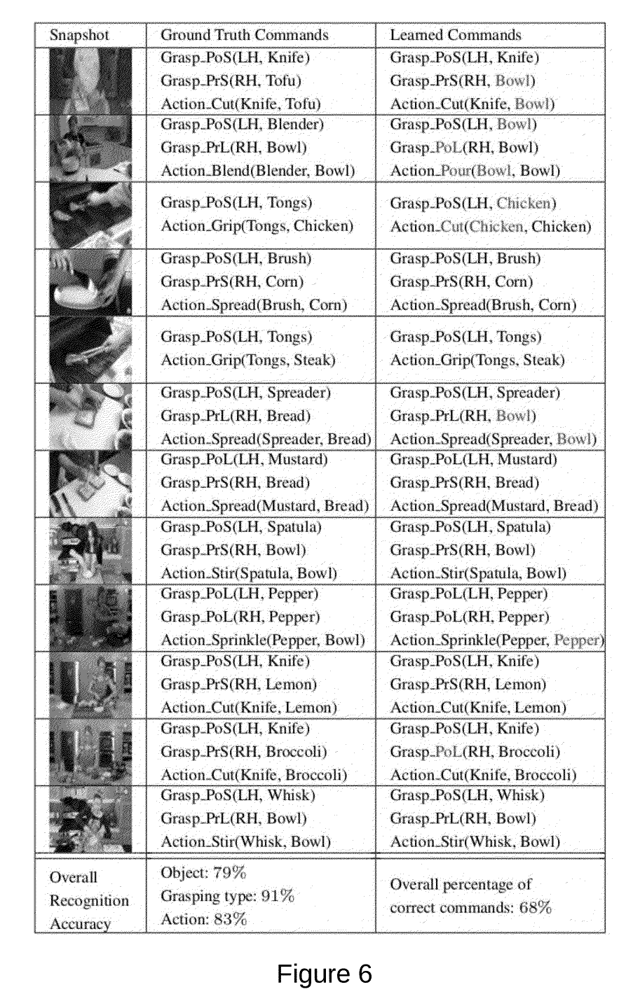

FIG. 6 illustrates final control commands generated by reverse parsing according to certain embodiments. A reversing parsing module 140 in FIG. 1 may take the output trees, such as those shown in FIG. 5, and may output them as commands.

As shown in FIG. 6, the commands may instruct a specific object to be held in a specific hand, either right hand (RH) or left hand (LH), with a specific power and grip, such as power-small (PoS), power-large (PoL), power-spherical (PoP), precision-small (PrS), and precision-large (PrL).

As described above, a CNN based object recognition module and CNN based grasping type recognition module can robustly recognize input frame patches from unconstrained videos into correct class labels. Additionally, the integrated system using the Viterbi parser 130 with a probabilistic extension of the manipulation action grammar can generate a sequence of execution commands robustly.

Various modifications to the above are possible. For example, the list of grasping types can be extended to have a finer categorization. Similarly, the number of objects can be extended to include more ingredients and/or tools. For example, “tofu” was not included in the set of training ingredient objects but was present in one of the videos in the example illustrated in FIG. 6. Additionally, certain embodiments may use the grasp type as an additional feature for action recognition, in addition to the objects.

Automatic segmentation of a long demonstration video into action clips may be done based on a change of grasp type. This may involve a separate segmentation module, not shown in FIG. 1.

The probabilistic manipulation action grammar discussed above is still a syntax grammar. In a variation, however, manipulation action grammar rules can be coupled with semantic rules using lambda expressions, through the formalism of combinatory categorical grammar.

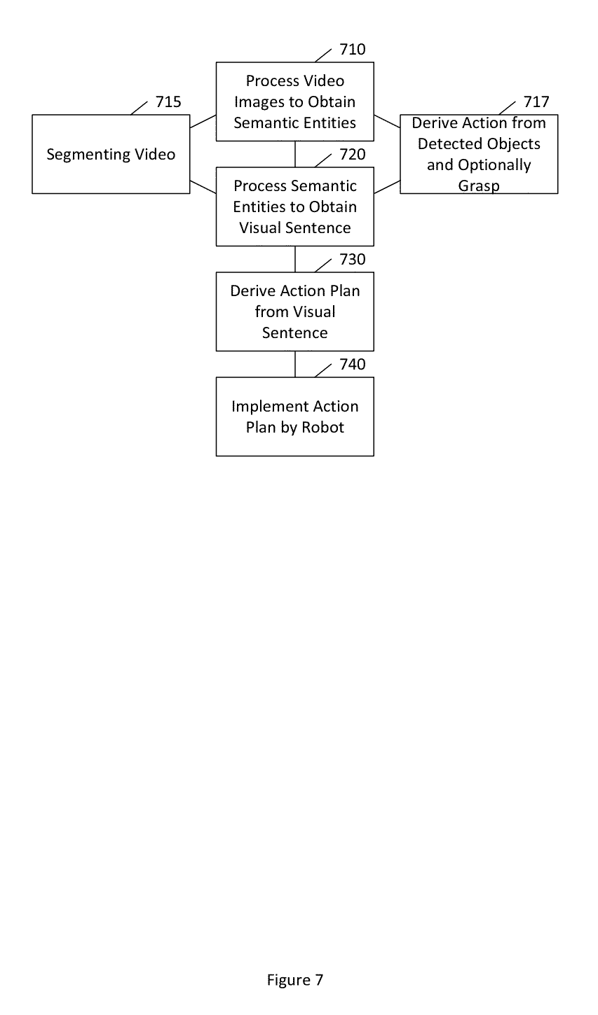

FIG. 7 illustrates a method according to certain embodiments. For example, as shown FIG. 7, the method can include, at 710, processing a set of video images to obtain a collection of semantic entities. The method can also include, at 720, processing the semantic entities to obtain at least one visual sentence from the set of video images. The method can further include, at 730, deriving an action plan for a robot from the at least one visual sentence. The method can additionally include, at 740, implementing the action plan by the robot.

The method, as to each of its steps, including the processing of the set of video images, the processing of semantic entities, and the deriving of the action plan can be computer implemented. For example, all of the steps may be performed by one computer or a variety of computers working together. Further discussion of such computer implementations can also be found with reference to FIG. 7.

In the method of FIG. 1, the set of video images can be from a single video or a single segment of a video. The method can further include, at 715, segmenting the video in time and extracting the semantic entities from each segment of the video. The segmentation may be based on, for example, detected changes in hand position. Thus, the semantic entities may be extracted from the video prior to segmentation, and the segmentation may be used in determining the visual sentence(s) to be formed.

The processing of the set of video images to obtain the collection of semantic entities can include applying a convolutional neural network for at least one object in the video images. Similarly, the processing of the set of video images to obtain the collection of semantic entities can include applying a convolutional neural network for at least one action in the video images. The at least one action can be a manipulation action, such as a grasping action.

The method can further include, at 717, deriving a task from at least a detected pair of objects in the set of video objects. Optionally, the deriving the task can further be based on a detected grasp type, as described above.

The semantic entities in certain embodiments can include at least one of a description of an action, a description of an object, and a description of a tool. The processing of the semantic entities can include applying a probabilistic variant of a content-free grammar. The processing of the semantic entities can include applying an explicit model of grasping type.

The deriving of the action plan can include reverse parsing the at least one visual sentence and generating a sequence of commands. The robot that implements certain embodiments can be an android or other humanoid robot that has a plurality of hands capable of holding objects and performing tasks based on computer commands.

In certain embodiments, the videos can be unconstrained videos, such as videos lacking special dimensional tagging or the like. These unconstrained videos may be obtained from public video sharing sites, such as YouTube (R).

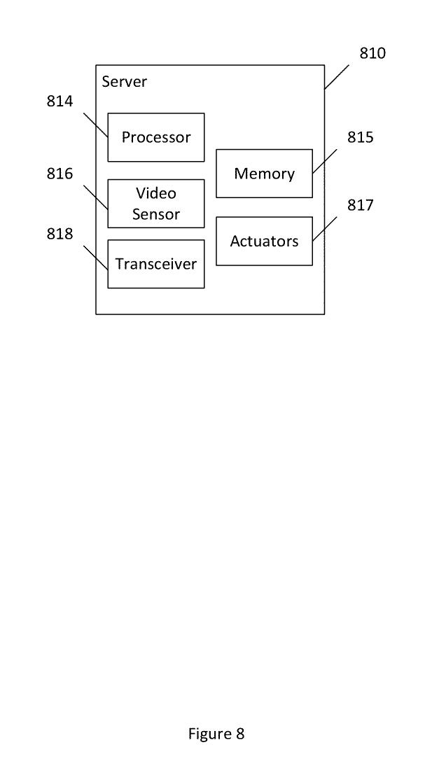

FIG. 8 illustrates a system according to certain embodiments. As shown in FIG. 8, the system can include a server 810, which can be a stand-alone computational system, or can be integrated into a robot.

The system can include at least one processor 814 and at least one memory 815. The memory 815 may include computer program instructions or computer code contained therein, for example for carrying out the embodiments described above.

Processor 814 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processor 814 may be implemented as a single controller, or a plurality of controllers or processors. Additionally, the processor 814 may be implemented as a pool of processors in a local configuration, in a cloud configuration, or in a combination thereof

For firmware or software, the implementation may include modules or units of at least one chip set (e.g., procedures, functions, and so on). Memory 815 may be any suitable storage device, such as a non-transitory computer-readable medium. A hard disk drive (HDD), random access memory (RAM), flash memory, or other suitable memory may be used. The memory 815 may be combined on a single integrated circuit as the processor 814, or may be separate therefrom. Furthermore, the computer program instructions may be stored in the memory 815 and which may be processed by the processor 814 can be any suitable form of computer program code, for example, a compiled or interpreted computer program written in any suitable programming language. Memory or data storage entity may be internal, external, or a combination thereof, such as in the case when additional memory capacity is obtained as an add-on or expansion. The memory may be fixed or removable.

The memory 815 and the computer program instructions may be configured, with the processor 814 for the particular device, to cause a hardware apparatus such as server 810, to perform any of the processes described above (see, for example, FIG. 7). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

The system may also include at least one video sensor 816. The video sensor 816 may be any video camera or similar image capturing device. The video sensor 816 may be configured to capture a live or previously recorded demonstration of an action to be learned by a robotic system. The video sensor 816 may include or be connected to a graphics card or other graphics processing hardware. Alternatively, one or more processor 814 may be employed to process images from the video.

The system can further include a plurality of actuators 817, such as robotic hands or robotic arms. These hands or arms may be provided with gripping effectors, such as vacuum effectors or pinchers. Other manipulators are also permitted as actuators 817.

The system may further include a transceiver 818. The transceiver 818 may be configured to receive data from an external source and to provide data to an external source. Thus, the transceiver 818 may be a wireless transceiver, or a wired transceiver. The transceiver 818 may, for example, include a network interface card or the like. The transceiver 818 may be used to obtain the video data instead of, or in addition to, the use of optional video sensor 816.

One having ordinary skill in the art will readily understand that the invention as discussed above may be practiced with steps in a different order, and/or with hardware elements in configurations which are different than those which are disclosed. For example, while the focus of the above discussion was on processing images, certain embodiments may also process the audio of an unconstrained video to provide additional input for determination of which action is being performed and/or which objects are involved in the action. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
processing a set of video images to obtain a collection of semantic entities;
processing the semantic entities to obtain at least one visual sentence from the set of video images;
deriving an action plan for a robot from the at least one visual sentence; and
implementing the action plan by the robot,
wherein the processing of the set of video images, the processing of semantic entities, and the deriving of the action plan are computer implemented.

2. The method of claim 1, wherein the set of video images comprise a single video.

3. The method of claim 1, further comprising:
segmenting the video in time, wherein semantic entities are extracted from each segment of the video.

4. The method of claim 1, wherein the processing of the set of video images to obtain the collection of semantic entities comprises performing applying a convolutional neural network for at least one object in the video images.

5. The method of claim 1, wherein the processing of the set of video images to obtain the collection of semantic entities comprises performing applying a convolutional neural network for at least one action in the video images.

6. The method of claim 5, wherein the at least one action comprises a manipulation action.

7. The method of claim 6, wherein the manipulation action comprises a grasping action.

8. The method of claim 1, further comprising:
deriving a task from at least a detected pair of objects in the set of video objects.

9. The method of claim 8, wherein the deriving of the task is further based on a detected grasp type.

10. The method of claim 1, wherein the semantic entities comprise at least one of a description of an action, a description of an object, and a description of a tool.

11. The method of claim 1, wherein the processing of the semantic entities comprises applying a probabilistic variant of a content-free grammar.

12. The method of claim 1, wherein the processing the semantic entities comprises applying an explicit model of grasping type.

13. The method of claim 1, wherein the deriving the action plan comprises reverse parsing the at least one visual sentence and generating a sequence of commands.

14. An apparatus, comprising:
at least one processor; and
at least one memory including computer program code,
wherein the at least one memory and the computer program code are configured to, with the at least one processor, cause the apparatus at least to
process a set of video images to obtain a collection of semantic entities;
process the semantic entities to obtain at least one visual sentence from the set of video images;
derive an action plan for a robot from the at least one visual sentence; and
implement the action plan by the robot.

15. The apparatus of claim 14, wherein the at least one memory and the computer program code are configured to, with the at least one processor, cause the apparatus at least to segment the video in time, wherein semantic entities are extracted from each segment of the video.

16. The apparatus of claim 14, wherein the at least one memory and the computer program code are configured to, with the at least one processor, cause the apparatus at least to derive a task from at least a detected pair of objects in the set of video objects.

17. A non-transitory computer-readable medium encoded with instructions that, when executed in hardware, perform a process, the process comprising:
processing a set of video images to obtain a collection of semantic entities;
processing the semantic entities to obtain at least one visual sentence from the set of video images;
deriving an action plan for a robot from the at least one visual sentence; and
implementing the action plan by the robot.

18. The non-transitory computer-readable medium of claim 1, the process further comprising:
segmenting the video in time, wherein semantic entities are extracted from each segment of the video.

19. The non-transitory computer-readable medium of claim 1, the process further comprising:
deriving a task from at least a detected pair of objects in the set of video objects.

20. The non-transitory computer-readable medium of claim 19, wherein the deriving the task is further based on a detected grasp type.
